(19) United States
(12) Patent Application Publication
(10) Pub. No.: US 2019/0001415 A1
(43) Pub. Date: Jan. 3, 2019

(54) METHOD FOR MANUFACTURING THREE-DIMENSIONALLY SHAPED OBJECT

(71) Applicant: PANASONIC INTELLECTUAL PROPERTY MANAGEMENT CO., LTD., Osaka (JP)

(72) Inventors: Masanori MORIMOTO, Osaka (JP); Satoshi ABE, Osaka (JP)

(73) Assignee: PANASONIC INTELLECTUAL PROPERTY MANAGEMENT CO., LTD., Osaka (JP)

(21) Appl. No.: 16/073,618

(22) PCT Filed: Jan. 19, 2017
(86) PCT No.: PCT/JP2017/001762

§ 371 Date: Jul. 27, 2018

(30) Foreign Application Priority Data
Jan. 29, 2016 (JP) 2016-016090
Jul. 25, 2016 (JP) 2016-145594

(51) Int. Cl. B22F 3/105; B29C 64/153; B29C 64/214; B33Y 10/00; B33Y 30/00

(52) U.S. Cl. CPC B22F 3/1055; B29C 64/153; B22F 2003/1056; B33Y 10/00; B33Y 30/00; B29C 64/214

(57) ABSTRACT

A method for manufacturing a three-dimensional shaped object comprising an undercut portion by alternate repetition of a powder-layer forming and a solidified-layer forming, the repetition comprising: (i) forming a solidified layer by irradiating a predetermined portion of a powder layer with a light beam, thereby allowing a sintering of the powder in the predetermined portion or a melting and subsequent solidification of the powder; and (ii) forming another solidified layer by newly forming a powder layer on the formed solidified layer, followed by an irradiation of a predetermined portion of the newly formed powder layer with the light beam. Especially, in the manufacturing method according to an embodiment of the present invention, a modeling process for pre-identifying the undercut portion is performed prior to a performance of the method.

### TECHNICAL FIELD

The disclosure relates to a method for manufacturing a three-dimensional shaped object. More particularly, the disclosure relates to a method for manufacturing a three-dimensional shaped object in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by newly forming a powder layer on the formed solidified layer, followed by similarly irradiating the powder layer with the light beam.

This kind of technology makes it possible to produce the three-dimensional shaped object with its complicated contour shape in a short period of time. The three-dimensional shaped object can be used as a metal mold in a case where an inorganic powder material (e.g., a metal powder material) is used as the powder material. While on the other hand, the three-dimensional shaped object can also be used as various kinds of models in a case where an organic powder material (e.g., a resin powder material) is used as the powder material.

Taking a case as an example wherein the metal powder is used as the powder material, and the three-dimensional shaped object produced therefrom is used as the metal mold, the selective laser sintering method will now be briefly described. As shown in FIGS. 9A-9C, a powder layer 22 with its predetermined thickness is firstly formed on a base plate 21 by a movement of a squeegee blade 23 (see FIG. 9A). Then, a predetermined portion of the powder layer is irradiated with a light beam L to form a solidified layer 24 (see FIG. 9B). Another powder layer is newly provided on the formed solidified layer, and is irradiated again with the light beam to form another solidified layer. In this way, the powder-layer forming and the solidified-layer forming are alternately repeated, and thereby allowing the solidified layers 24 to be stacked with each other (see FIG. 9C). The alternate repetition of the powder-layer forming and the solidified-layer forming leads to a production of a three-dimensional shaped object with a plurality of the solidified layers integrally stacked therein. The lowermost solidified layer 24 can be provided in a state of being adhered to the surface of the base plate 21. Therefore, there can be obtained an integration of the three-dimensional shaped object and the base plate. The integrated three-dimensional shaped object and base plate can be used as the metal mold.

### PATENT DOCUMENTS (RELATED ART PATENT DOCUMENTS)

PATENT DOCUMENT 1: Japanese Unexamined Patent Application Publication No. H01-502890

### DISCLOSURE OF THE INVENTION

### Problems to be Solved by the Invention

The inventors of the present application have found that the following problems may occur upon a manufacture of a three-dimensional shape object comprising a so-called “undercut portion”. Specifically, the inventors of the present application have found that a bulge 18 (i.e., raised portion) may arise in a case that a formation of the undercut portion is performed (see FIG. 7A), the bulge 18 having a size larger than that arising in a case that no formation of the undercut portion is performed (see FIG. 7B). In particular, the inventors of the present application have found that, as the undercut part 10 has an inclined configuration not being close to a vertical configuration, the size of the bulge 18 tends to be much larger at a periphery of the undercut part 10 (see FIGS. 7A-7C).

In a case that the bulge 18 having a much larger size may arise, the squeegee blade 23 may contact the bulge 18 to be used for forming the next powder layer (see FIGS. 8A and 8B). As a result, a part of the solidified layer 24 at the formation region of the undercut portion 10 may be peeled off together with the bulge 18 (see FIG. 8c). Therefore, the peel off of the part of the solidified layer 24 makes a formation of a desired powder layer on the solidified layer 24 difficult.

In view of the above, upon the manufacture of the three-dimensional shaped object having the undercut portion 10, a machine process for removing the bulge 18 at the formation region of the undercut portion 10 may be necessary. In this regard, it is conceivable to check the arising of the bulge 18 and then to sequentially subject the arising portion of the bulge 18 to the machine process. However, the sequential machine process may make an efficient manufacture of the three-dimensional shaped object difficult. Specifically, the sequential machine process may make an overall detection of the arising portion of the bulge 18 difficult.

Under these circumstances, the present invention has been created. That is, an object of the present invention is to provide the selective laser sintering method which is capable of more efficiently manufacturing a three-dimensional shaped object comprising an undercut portion.

### Means for Solving the Problems

In order to achieve the above object, an embodiment of the present invention provides a method for manufacturing a three-dimensional shaped object comprising an undercut portion by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by newly forming a powder layer on the formed solidified layer, followed by an irradiation of a predetermined portion of the newly formed powder layer with the light beam,

wherein a modeling process for pre-identifying the undercut portion is performed prior to a performance of the method.

### Effect of the Invention

In the manufacturing method according to an embodiment of the present invention, it is possible to more efficiently manufacture a three-dimensional shaped object comprising an undercut portion.

### BRIEF DESCRIPTION OF THE DRAWINGS

FIG. 1 is a schematic diagram of an undercut portion (where FIG. 1(a) is a schematic perspective view, and FIG. 1(b) is a schematic enlarged cross-sectional view).

FIG. 2 is a perspective view schematically showing a modeling process for identifying the undercut portion (where FIG. 2(a) is a model configuration of a three-dimensional shaped object, FIG. 2(b) is a model configuration of the three-dimensional shaped object being divided into pieces, and FIG. 2(c) is a surface of the extracted undercut portion).

FIG. 3 is a schematic view showing a process for determining a path for a machine process (where FIG. 3(a) is a model of the three-dimensional shaped object including the undercut portion, FIG. 3(b) is a plurality of slice faces extracted from the model of the three-dimensional shaped object including the undercut portion, and FIG. 3(c) illustrates the process for determining the path for the machine process for a contour of a solidified layer at a formation region of the undercut portion).

FIG. 4 is a perspective view schematically showing an aspect of adding to the machine process an upper surface of the solidified layer at the formation region of the undercut portion (where FIG. 4(a) illustrates a state prior to the machine process and FIG. 4(b) illustrates a state after the machine process).

FIG. 5 is a cross-sectional view schematically showing the undercut portion having a bulge.

FIG. 6 is a cross-sectional view schematically showing the three-dimensional shaped object having an internal space region.

FIG. 7 is a cross-sectional view schematically showing various arising states of the bulge (where FIG. 7(a) illustrates the undercut portion having a relatively large steep angle θ, FIG. 7(b) illustrates a periphery of the solidified layer having a vertical inclined configuration, and FIG. 7(c) illustrates the undercut portion having a relatively small steep angle θ).

FIG. 8 is a cross-sectional view schematically showing an aspect of newly forming a powder layer using a squeegee blade in a state where the bulge is generated (where FIG. 8(a) illustrates before the squeegee blade contacts the bulge, FIG. 8(b) illustrates a point in time when the squeegee blade contacts the bulge, and FIG. 8(c) illustrates after the squeeze blade contacts the bulge).

FIG. 9 is a cross-sectional view schematically illustrating an aspect of a laser-sintering/machining hybrid process in which a selective laser sintering method is performed (where FIG. 9(a) illustrates a state when forming the powder layer, FIG. 9(b) illustrates a state when forming the solidified layer, and FIG. 9(c) illustrates a state during lamination).

FIG. 10 is a perspective view schematically illustrating a configuration of the laser-sintering/machining hybrid machine.

FIG. 11 is a flow chart illustrating general operations of the laser-sintering/machining hybrid machine.

### MODES FOR CARRYING OUT THE INVENTION

The manufacturing method according to an embodiment of the present invention will be described in more detail with reference to the accompanying drawings. It should be noted that forms/forms and dimensional proportions in the drawings are merely for illustrative purposes, and thus not the same as those of the actual parts or elements.

The term “powder layer” as used in this description and claims means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The term “upward/downward” direction directly or indirectly described herein corresponds to a direction based on a positional relationship between the base plate and the three-dimensional shaped object. Aside for manufacturing the three-dimensional shaped object is defined as the “upward direction”, and a side opposed thereto is defined as the “downward direction” when using a position at which the base plate is provided as a standard.

### [Selective Laser Sintering Method]

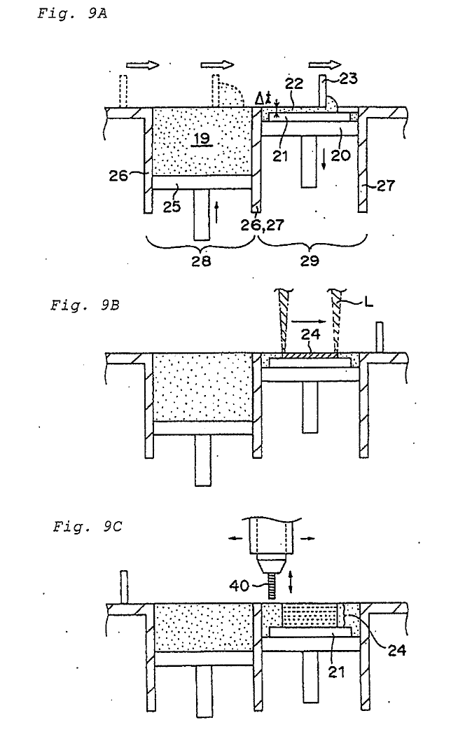

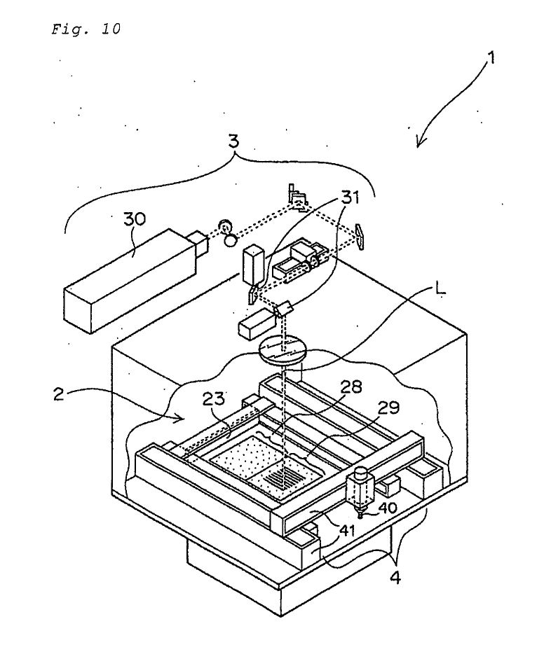

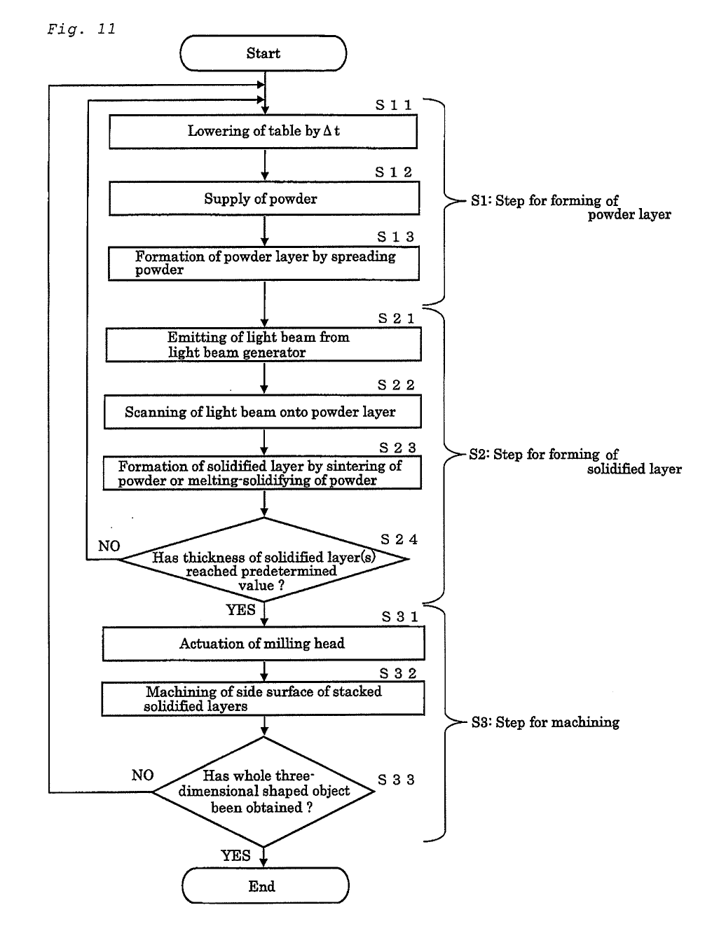

First of all, a selective laser sintering method, on which an embodiment of the manufacturing method of the present invention is based, will be described. By way of example, a laser-sintering/machining hybrid process wherein a machining is additionally carried out in the selective laser sintering method will be explained. Each of FIGS. 9A-9C schematically shows a process embodiment of the laser-sintering/machining hybrid. FIGS. 10 and 11 respectively show major constructions and operation flow regarding a metal laser sintering hybrid milling machine for enabling an execution of a machining process as well as the selective laser sintering method.

As shown in FIGS. 9A-9C and 10, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder) as shown in FIGS. 9A-9C. The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 9A-9C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a shaped object. The base plate is disposed on the forming table 20 and serves as a platform of the three-dimensional shaped object.

As shown in FIG. 10, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 10, the machining means 4 is mainly composed of a milling head 40 and an actuator 41. The milling head 40 is a cutting tool for milling the side surface of the stacked solidified layers, i.e., the surface of the three-dimensional shaped object. The actuator 41 is a means for driving the milling head 40 to move toward the position to be milled.

Operations of the laser sintering hybrid milling machine 1 will now be described in detail. As can been seen from the flowchart of FIG. 11, the operations of the laser sintering hybrid milling machine are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 9A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 9B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 9C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The milling head 40 (see FIG. 9C and FIG. 10) is actuated to initiate an execution of the machining step (S31). For example, in a case where the milling head 40 has an effective milling length of 3 mm, a machining can be performed with a milling depth of 3 mm. Therefore, supposing that “Δt” is 0.05 mm, the milling head 40 is actuated when the formation of the sixty solidified layers 24 is completed. Specifically, the side face of the stacked solidified layers 24 is subjected to the surface machining (S32) through a movement of the milling head 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### [Manufacturing Method of the Present Invention]

A manufacturing method according to an embodiment of the present invention is characterized by a preprocessing prior to a manufacture of the three-dimensional shaped object in the selective laser sintering method as described above.

Specifically, a modeling process for pre-identifying (i.e., identifying in advance) an undercut portion is performed prior to the manufacture of the three-dimensional shaped object. The undercut portion is a portion having a “steep” configuration in the three-dimensional shape object. Namely, a process for pre-identifying such the undercut portion is performed.

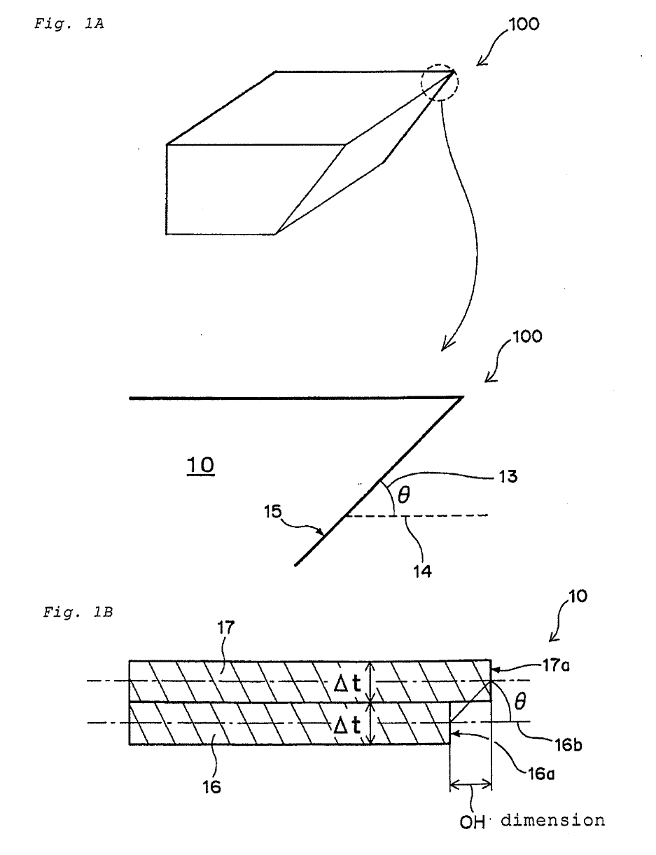

FIG. 1A and FIG. 1B show an undercut portion 10. The phrase “undercut portion” as used herein means a portion having a steep angle 13 in a broad sense as shown in FIG. 1A. The phrase “steep angle θ” indicates an angle (less than 90 degree) provided between a lower inclined surface 15 of the three-dimensional shaped object and a horizontal surface 14 as shown in FIG. 1A. As can be seen from the shown embodiment, the larger steep angle θ leads to a provision of the undercut portion 10 having a more vertical inclined configuration.

The undercut portion 10 is a part of the three-dimensional shaped object. Thus, the undercut portion 10 is composed of stacked solidified layers (see FIG. 1B). Therefore, the phrase “undercut portion” has such a configuration that the other solidified layer 17 protrudes outward from the one solidified layer 16 in a narrow sense as shown in FIG. 1B. More specifically, the undercut portion 10 is configured that an angle θ (i.e., steep angle) between a line segment connecting an end face 16a of the one solidified layer 16 with an end face 17a of the other solidified layer 17 and a horizontal face 16b of the one solidified layer 16 formsed angle θ (sharp angle) is less than 90 degree. Furthermore, a protrusion dimension of the other solidified layer 17 from one solidified layer 16, i.e., an overhang dimension (OH dimension) can be expressed by the following equation in a case that a height dimension of each solidified layer is Δt. The one solidified layer 16 and the other solidified layer 17 as used herein are not necessarily limited to be adjacent to each other but may be spaced apart from each other.

Protrusion dimension(OH dimension)=Δt/tan θ [Expression 1]

The modeling process in the present invention can be performed on a computer based on design data (e.g., so-called CAD data) of the three-dimensional shaped object. In a case of using the CAD data of the three-dimensional shaped object, a process for specifying the undercut portion is performed on the CAD. Specifically, the modeling process according to the present invention is characterized in that, based on a design data of the three-dimensional shaped object to be manufactured, an extraction of a region corresponds to a surface region of the undercut portion from a surface region of the three-dimensional shaped object is performed. Namely, in the present invention, a formation region of the undercut portion where a relatively large bulge (i.e., raised portion) may arise is pre-specified or specified in advance. Thus, it is possible to determine in advance a more appropriate path for a machine process upon the machine process of a predetermined region of the undercut portion where a relatively large bulge may arise, specifically, upon the machine process of a contour-upper surface of the solidified layer (i.e., an upper surface of a contour or a profile or an outline of the solidified layer) at the formation region of the undercut portion is performed. As a result, compared with the case that an arising portion of the bulge is confirmed and specified, and then the arising portion is sequentially subjected to the machine process, a confirmation and an identification of the arising portion of the bulge and also sequential machine process for the arising portion are not necessary. Thus, a reduction of a necessary time for the machine process as a whole is possible. Accordingly, it is possible to make the manufacture time of the three-dimensional shaped object shorter as a whole, and thus more efficient manufacture thereof can be realized.

In a preferable embodiment, a surface of a model of the three-dimensional shaped object is divided into a plurality of pieces in the modeling process, and an extraction for a surface of the undercut portion is performed from the surface of the model of the three-dimensional shaped object, based on a direction of a normal vector of each of the plurality of the pieces divided. Namely, an extraction of the surface of the undercut portion is performed based on the normal vector of the surface region obtained from the design data of the three-dimensional shaped object. The term “extraction” as used herein substantially means “a pick out” or “a pull out” of a surface region of a predetermined portion corresponding to the undercut portion from an entire surface of the three-dimensional shaped object by a computer processing. The phrase “three-dimensional shaped object-model (i.e., model of three-dimensional shaped object)” substantially means a model configuration of the three-dimensional shaped object to be manufactured on the computer.

Preferably, the piece having the normal vector with its direction downwardly oriented to a horizontal direction is regarded as the surface of the undercut portion for the extraction. Namely, only the piece having the normal vector with a predetermined direction is selected from a plurality of normal vectors. The term “horizontal” as used herein substantially means a direction perpendicular to a laminated direction of the solidified layer. A more specific example includes that a width direction of the solidified layer corresponds to the “horizontal” direction.

In a preferable embodiment, an extraction for a plurality of slice faces is performed from the model of the three-dimensional shaped object to be manufactured, a contour of a portion corresponding to the undercut portion in a contour of each of the extracted faces is identified, a selection of a plurality of points in the identified contour is performed, and a coordinate information on each of selected points is obtained. Namely, the coordinate information on an arbitrary point of the contour of a predetermined portion corresponding to the undercut portion in the model of the three-dimensional shaped object is obtained by a computer processing.

In a preferable embodiment, the manufacturing method of the three-dimensional shaped object comprises a performance of a machine process for a contour-upper surface of the solidified layer at the undercut portion. Specifically, only the upper surface of the contour of the solidified layer at the undercut portion where a relatively large bulge may arise during the manufacture of the three-dimensional shaped object is subjected to the machine process. Such the machine process can prevent the squeegee blade to be used for newly forming the powder layer from contacting the bulge. Therefore, it can prevent a part of the solidified layer at the undercut portion from being peeled off together with the bulge. As a result, it is possible to adequately form a desired new powder layer on the solidified layer. The phrase “bulge” as used herein means a protrusion arising at the contour of the solidified layer in a process that a formation of the solidified layer is performed by irradiating the powder layer with the light beam, the protrusion corresponding to a raised portion arising at an end portion of the solidified layer. The phrase “bulge” as used herein specifically means a protrusion arising at the contour of the solidified layer in the predetermined portion corresponding to the undercut portion, the protrusion corresponding to a raised portion arising at an end portion of the solidified layer. Although not being bound by any particular theory, upon an irradiation of the powder layer with the light beam, a surrounding powder region is also irradiated with the light beam, and thereby a surface tension inducing a rise occurs due to a melting phenomenon. As a result, it is conceivable that the bulge may tend to arise at the contour of the solidified layer.

In a preferable embodiment, a formation of a path for the machine process is performed based on a coordinate information, and the contour-upper surface of the solidified layer at the undercut portion is subjected to the machine process in accordance with the path for the machine process, the coordinate information being that on a plurality of points selected from a contour of a predetermined portion corresponding to the undercut portion. Specifically, the contour-upper surface of the solidified layer at the undercut portion where the relatively large bulge may arise upon the manufacture of the three-dimensional shaped object, is subjected to the machine process in accordance with the path for the machine process determined in advance. A determination in advance of the path for the machine process may allow a more efficient machine process for the contour-upper surface of the solidified layer at the undercut portion where the relatively large bulge may arise upon the manufacture of the three-dimensional shaped object. Therefore, it is possible to shorten the machine process-time for the contour-upper surface of the solidified layer in the undercut portion where a relatively large bulge may arise during the manufacture of the three-dimensional shaped object, and also to avoid a contact of the squeegee blade to be used for newly forming the next powder layer with the bulge.

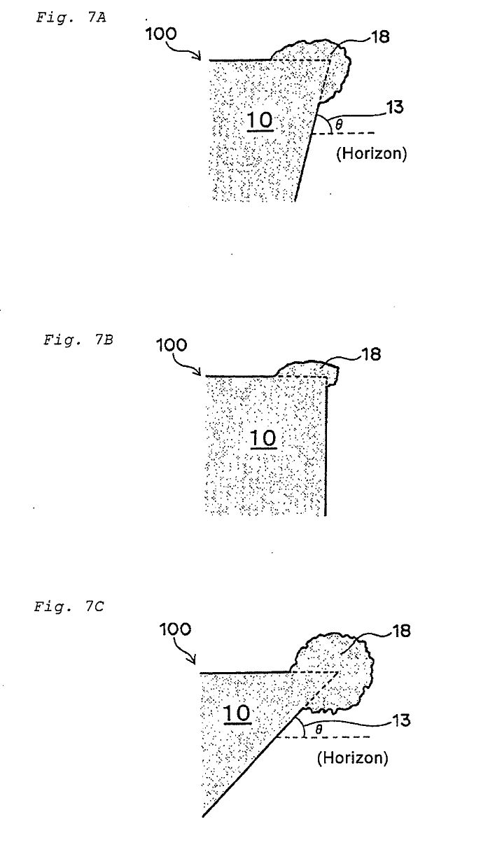

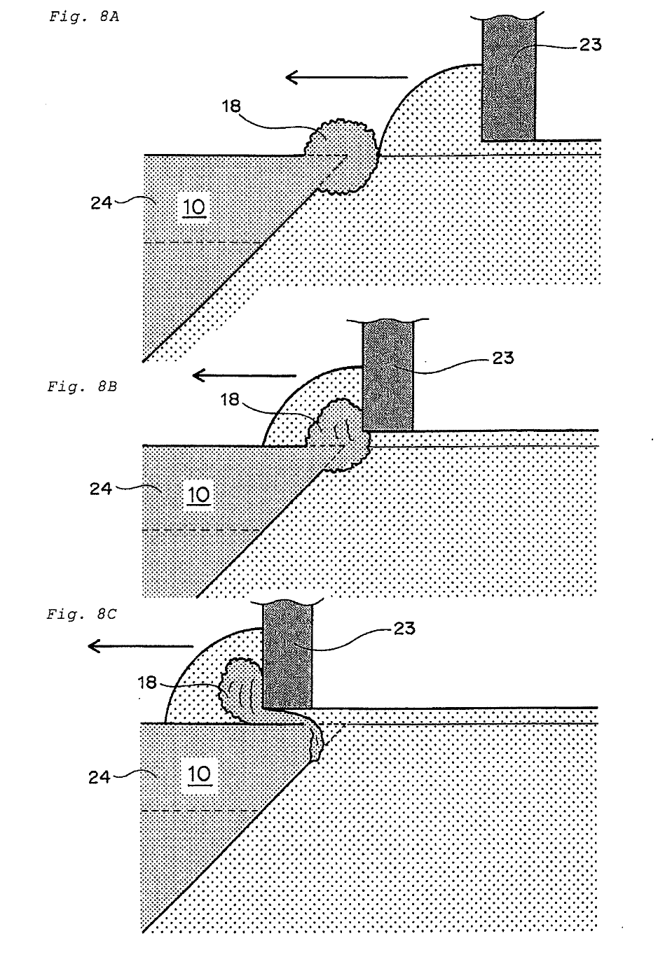

In a preferred embodiment, depending on the steep angle at the undercut portion, a necessity of the machine process for the contour-upper surface of the solidified layer at the undercut portion is determined. The undercut portion 10 having a larger steep angle θ leads to a provision of the undercut portion 10 having an inclined configuration being close to a vertical configuration, whereas the undercut portion 10 having a smaller steep angle θ leads to a provision of the undercut portion 10 having a inclined configuration not being close to the vertical configuration (See FIG. 7). In this respect, the bulge 18 arising at the undercut portion 10 tends to be larger as the undercut portion 10 has the inclined configuration not being close to the vertical configuration. Thus, a size of the bulge 18 is grasped indirectly from the steep angle θ, and thereby the necessity of the machine process for the contour-upper surface of the solidified layer in the undercut portion is determined. For example, in only the case that it can be determined or judged that the bulge 18 obstructs a movement of the squeegee blade 23 during the formation of the powder layer due to the undercut portion having the relatively small steep angle θ (i.e., the undercut portion 10 having the inclined configuration not being close to the vertical configuration), the contour-upper surface of the solidified layer in the undercut portion 10 may be subjected to the machine process. In contrast, in a case that it can be determined or judged that the bulge 18 does not obstruct the movement of the squeegee blade 23 during the formation of the powder layer due to the undercut portion 10 having the relatively large steep angle θ (i.e., the undercut portion 10 having the inclined configuration being close to the vertical configuration), the contour-upper surface of the solidified layer in the undercut portion 10 may not be subjected to the machine process.

### Technical Idea of the Present Invention

A technical idea of the present invention will be described. The present invention is based on such a technical idea that “a portion where a large bulge may arise upon a formation of the solidified layer is specified in advance and also a more suitable path for a machine process is determined in advance”.

The inventors of the present application have found a phenomenon that a relatively large bulge 18 tends to arise at the undercut portion 10, and thus the present invention has been created in light of such the phenomenon. Furthermore, the inventors of the present invention have also found that a size of the bulge 18 arising at the undercut portion 10 may change depending on a difference of the steep angle in the undercut portion 10. Thus, the present invention also has been created to provide a more suitable solution for the undercut portion 10 where the size of the bulge may change depending on the difference of the steep angle.

According to such the technical idea of the present invention, the formation region of the undercut portion where the bulge having larger size may arise can be specified in advance. As a result, it is possible to more efficiently manufacture the three-dimensional shaped object.

Specifically, the identification in advance of the formation region of the undercut portion makes it possible to determine in advance more adequate path for the machine process upon the machine process for a predetermined portion of the undercut part where a relatively large bulge may arise, the predetermined portion of the undercut part corresponding to the contour-upper surface of the solidified layer. Therefore, compared with a case that the confirmation and identification of the arising (i.e., the arising portion) of the bulge is performed and the arising portion thereof is sequentially subjected to the machine process, the confirmation and identification of the arising portion of the bulge and the sequential machine process of the arising portion thereof are not necessary. Thus, a time for the machine process can be reduced as a whole. Namely, the present invention has an advantage in that it is possible to pre-identify or identify in advance a predetermined portion of the undercut portion where the machine process is necessary due to the arising of the relatively large bulge, without confirming and identifying the arising (i.e., the arising portion) of the bulge and then performing the sequential machine process. Accordingly, it is possible to shorten the manufacture time of the three-dimensional shaped object as a whole, and thus more efficient manufacture thereof can be realized.

Hereinafter, the method of manufacturing the three-dimensional shaped object according to an embodiment of the present invention will be more specifically described. The present invention can be mainly composed of a computer processing to be performed as a pre-processing and subsequently a manufacture of the three-dimensional shape object in accordance with the selective laser sintering method.

“Pre-processing (i.e., computer processing)” Firstly, a pre-processing on a condition of a use of a computer prior to manufacture of the three-dimensional shaped object will be described. As the pre-processing, the following (1) and (2) are preferably performed.

### (1) Identification of Undercut Portion

First, a modeling processing is performed using CAD software prior to the manufacture of the three-dimensional shaped object. Specifically, for example, the modeling process is performed using so-called “STL format” CAD software. The modeling process corresponds to a computer process for pre-specifying or specifying in advance the undercut portion.

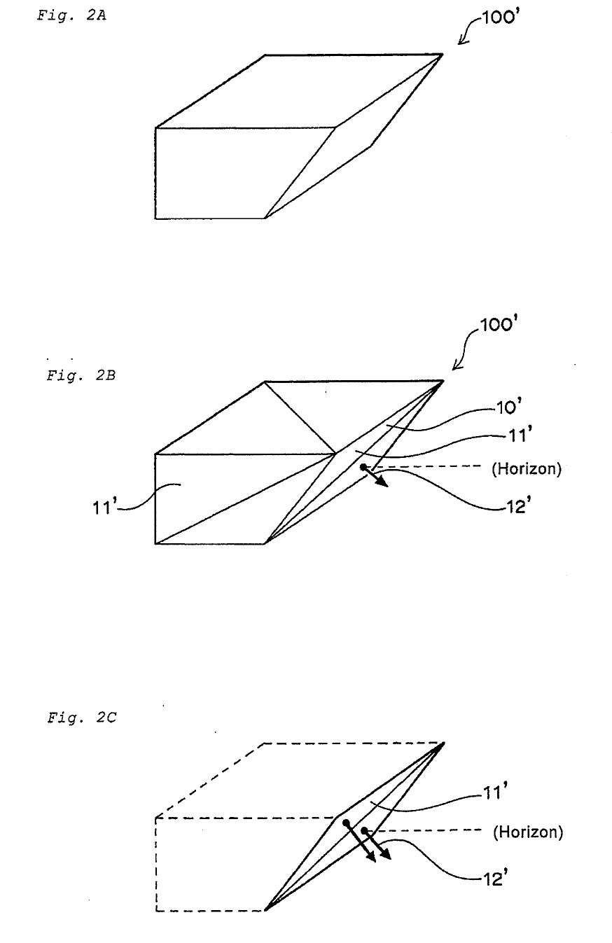

In the modeling process, as shown in FIGS. 2A and 2B, the surface of the three-dimensional shaped object model 100′ is divided into a plurality of pieces 11′. Preferably, an entire surface of the three-dimensional shaped object model 100′ is divided into a plurality of pieces 11′ having geometric shape. As shown, the entire surface of the three-dimensional shaped object model 100′ may be divided into triangular pieces 11′ for example.

After dividing it into a plurality of pieces 11′, as shown in FIG. 2B, a direction of a vector perpendicular to the surface of each piece 11′, that is, a direction of a normal vector 12′ of each piece 11′ is calculated for each piece 11′. More specifically, a center coordinate (i.e., center point) of each piece 11′ is calculated based on each of vertex coordinates of each piece 11′, and then the direction of a vector (i.e., normal vector 12′) perpendicular to the center coordinate is calculated.

After calculating the direction of the normal vector 12′ for each piece 11′, as shown in FIGS. 2B and 2C, only the piece 11′ having the normal vector 12′ with its direction downwardly oriented to a horizontal direction is extracted or picked out. In the present invention, the piece 11′ having the normal vector 12′ with its direction downwardly oriented to the horizontal direction is regarded as the surface of the undercut portion 10′. Although not shown, the piece 11′ having the normal vector 12′ with its direction upwardly oriented to the horizontal direction is regarded as a surface of a predetermined portion other than the undercut portion 10′. Thus, the extraction or the pick out of the piece 11′ regarded as the surface of the predetermined portion other than the undercut portion 10′ is not performed.

As described above, in the present invention, the extraction of the surface of the undercut portion 10′ from the entire surface of the three-dimensional shape model 100′ is performed based on the direction of the normal vector 12′ of each of the plurality of pieces 11′.

### (2) Determination of Path for Machine Process

After identifying the undercut portion 10′, a computer processing is performed to determine a path for the machine process of a predetermined portion of the undercut portion 10′, the predetermined portion of the undercut portion 10′ corresponding to the contour-upper surface of the solidified layer. In such the processing, CAD/CAM software or the like may be used as necessary.

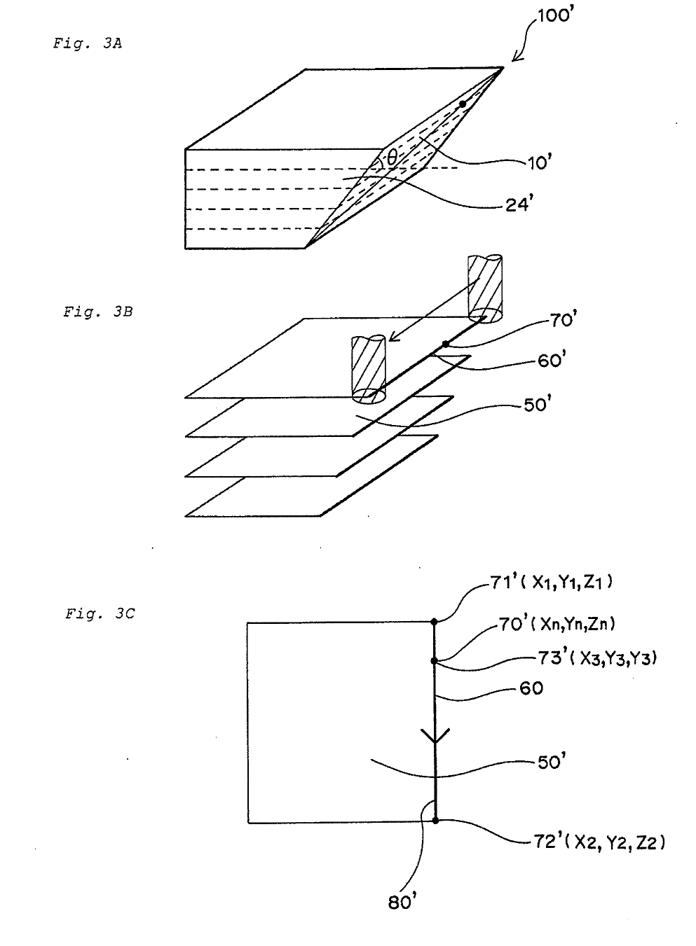

Firstly, as shown in FIGS. 3A and 3B, an extraction or a pick out of a plurality of slice faces 50′ is performed from a three-dimensional shaped object model 100′ including the undercut portion 10′ in which a formation portion has been specified. The slice face 50′ is a face to be obtained by slicing the three-dimensional shaped object model 100′ with a stacked pitch of the solidified layer 24′ along the horizontal direction, for example. After the extraction or the pick out of the plurality of slice faces 50′, as shown in FIGS. 3B and 3C, a contour 60′ at the undercut portion 10′ is specified from a contour 60′ of each slice face 50′, the contour 60′ at the undercut portion 10′ corresponding to a bold line in FIGS. 3B and 3C. After specifying the contour 60′ at the undercut part 10′, an arbitrary plurality of points 70′ are selected from the contour 60′. In order to specify a position of the contour 60′ of the undercut part 10′ in the contour 60′ of the slice face 50′, a position information of the undercut part 10′ extracted by the modeling process may be utilized. As shown in FIG. 3C, the plurality of points 70′ to be selected include, for example, a first point 71′ at one end of the contour 60′ of the undercut portion 10′, a second point 72′ at the other end of the contour 60′, and a third point 73′ between the first point 71′ and the second point 72′.

After selecting the arbitrary plurality of points 70′, a coordinate information (xₙ, yₙ, zₙ) on each point 70′ is obtained. An obtainment of the coordinate information (xₙ, yₙ, zₙ) on each point 70′ may make it possible to accurately grasp in space a position of each point 70′ in the three-dimensional shape model 100′. For example, in the case of selecting the first point 71′, the second point 72′ and the third point 73′, the coordinate information on each of the first point 71′, the second point 72′ and the third point 73′ is obtained. Specifically, it is obtained that the coordinate of the first point 71′ is (x₁, y₁, z₁), that the coordinate of the second point 72′ is (x₂, y₂, z₂), and also that the coordinate us (x₃, y₃, z₃). In the case of slicing the three-dimensional shaped object model 100′ along the horizontal direction as described above, the z coordinate (i.e., z₁) of the first point 71′, the z coordinate (i.e., z₂) of the point 72′, and the z coordinate (i.e., z₃) of the third point 73′ of one slice face 50′ at a predetermined position may be equal respectively.

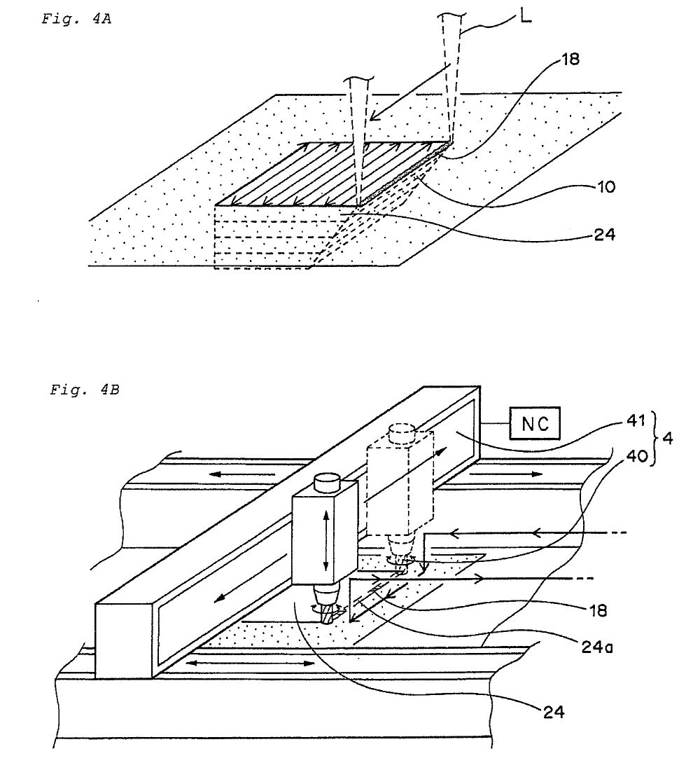

After obtaining the coordinate information on each point, a path for the machine process 80′ passing through each point is determined. It is preferable to select a path for the machine process, the pass corresponding to a pass making it possible to more efficiently subject the contour-upper surface 24a of the solidified layer 24 in the formation region of the undercut portion 10 to the machine process upon the manufacture of the three-dimensional shaped object as described below (see FIG. 4). Specifically, a determination of a path for the machine process 80′ is performed, the pass corresponding to a pass making it possible to provide the machine tool having the shortest moving distance. This makes it possible to shorten the time for the machine process of the contour-upper surface 24a of the solidified layer 24 in the undercut portion 10 (refer to FIGS. 4A and 4B) during the manufacture of the three-dimensional shaped object as described below. For example, in the case that the first to third points are selected from the contour 60′ of the undercut portion 10′ as described above, the following path for the machine process is selected as the path for the machine tool having the shortest moving distance. The pass corresponds to a pass in which the machine tool can sequentially pass through the first point 71′, the third point 73′, and the second point 72′. The present invention is not limited to this embodiment. For example, the following another path for the machine process may be selected. Another pass corresponds to a pass in which the machine tool can sequentially pass through the second point 72′, the third point 73′, and the first point 71′.

Furthermore, together with the above-described determination of the path for the machine process 80′, an operation condition of a machine tool may be determined in advance, the machine tool being used upon the machine process for the contour-upper surface 24a of the solidified layer 24 in the undercut portion 10 during the manufacture of the three-dimensional shaped object (See FIGS. 4A and 4B). For example, considering that the dimension of the bulge depending on the steep angle θ (see FIG. 3A) of the undercut portion 10′ may change, a combination of the operation condition of “rotation of the end mill in a clockwise direction at a speed of 3000 rotation/min” and the operation condition of “movement speed of the end mill at a speed of 500 mm/min from the one end to the other end thereof” may be determined in advance.

In view of the above, prior to the manufacture of the three-dimensional shaped object, a database on (1) the path for the machine process and (2) the operation condition of the machine tool is constructed in advance, each of which being for subjecting the contour-upper surface 24a of the solidified layer 24 in the formation region of the undercut portion 10 to the machine process during the manufacture of the three-dimensional shaped object. A construction of the database in advance may make it possible to adequately control the machine process for the contour-upper surface 24a of the solidified layer 24 in the formation region of the undercut portion 10 upon the manufacture of the three-dimensional shaped object later (see FIGS. 4A and 4B).

“Upon performing of selective laser sintering method” An embodiment upon the manufacture of the three-dimensional shaped object will be described hereinafter.

Upon the manufacture of the three-dimensional shaped object, based on the path for the machine process determined in advance prior to the manufacture thereof, the contour-upper surface 24a of the solidified layer 24 in the formation region of the undercut portion 10 may be subjected to the machine process as shown in FIGS. 4A and 4B.

Specifically, based on the coordinate information of each point 70′ for forming the path for the machine process 80′ determined in advance (see FIG. 3C) determined in advance by the computer processing, an actual pass for the machine process of the machine means 4 to be used upon an actual machine process may be controlled, the machine means 4 being used to subject the contour-upper surface 24a of the solidified layer 24 to the machine process. More specifically, a numerical control (NC: Numerical Control) machine tool or a similar one, which is referred to as NC machine tool or the like hereinafter, is used as the machine means 4. On a condition of a use of the NC machine tool or the like, a numerical information obtained by program conversion from a coordinate information may be commanded to the NC machine tool or the like, the coordinate information being a coordinate information on each point 70′ obtained by the computer processing. Accordingly, it is possible to adequately control the path for the machine process of an end mill 40, the end mill 40 being a component of the machine means 4 to be used as the NC machine tool or the like.

In the case that a path having the shortest moving distance of the machine tool, i.e., end mill 40 is selected as the “pre-determined path for the machine process” in the computer processing, it is possible to adequately reduce the time for the machine process of the contour-upper surface 24 a of the solidified layer 24 in the formation region of the undercut portion 10. As a result, the manufacture time of the three-dimensional shaped object can be further shortened as a whole.

Furthermore, during the manufacture of the three-dimensional shaped object, the contour-upper surface 24 a of the solidified layer 24 in the formation region of the undercut portion 10 may be subjected to the machine process based on the pre-determined the operation condition of the machine means determined prior to the manufacture of the three-dimensional shaped object.

Specifically, a movement of the machine means 4 may be controlled during the actual machine process based on the pre-determined (i.e., determined in advance) operation conditions of the machine means by the computer processing. More specifically, the numerical control (NC: Numerical Control) machine tool or a similar one, which is referred to as NC machine tool or the like hereinafter, is used as the machine means 4. On a condition of a use of the NC machine tool or the like, a numerical information obtained by program conversion from the operation condition of the machine means obtained by the computer processing may be commanded to the NC machine tool or the like. For example, the numerical information obtained by program conversion from a pre-determined (i.e., determined in advance) operation condition of the machine means obtained by the computer processing may be commanded to the NC machine tool or the like, the pre-determined operation condition corresponding to a combination of the operation condition of “rotation of the end mill in the clockwise direction at the speed of 3000 rotation/min” and the operation condition of “movement speed of the end mill at the speed of 500 mm/min from the one end to the other end thereof”. Accordingly, the movement based on the numerical information makes it possible to adequately control the operation condition of the end mill 40, the end mill 40 being a component of the machine means 4 to be used as the NC machine tool or the like.

As described above, the path for the machine process and the operating condition of the end mill 40, which is a component of the machine means 4 to be used as the NC machine tool or the like, can be adequately controlled. Thus, during the manufacture of the three-dimensional shaped object, the contour-upper surface 24a of the solidified layer 24 in the formation region of the portion 10 can be efficiently subjected to the machine process. Therefore, it is possible to shorten the machine time of the contour-upper surface of the solidified layer in the undercut portion where a relatively large bulge may arise. Also, such the machine process allows a prevention of the contact of the squeegee blade to be used for forming the next powder layer with the bulge. Therefore, it is possible to prevent the solidified layer in the undercut portion from being peeled off together with the bulge. As a result, a desired new powder layer can be adequately formed on the solidified layer. Accordingly, an adequate manufacture of a desired three-dimensional shaped object is finally possible.

The manufacturing method of the present invention can adopt various embodiments.

### <Machine Process Based on Steep Angle>

For example, according to the present invention, depending on the inclined portion of the undercut portion, a necessity of the machine process for the contour-upper surface of the solidified layer at the undercut portion may be determined in advance.

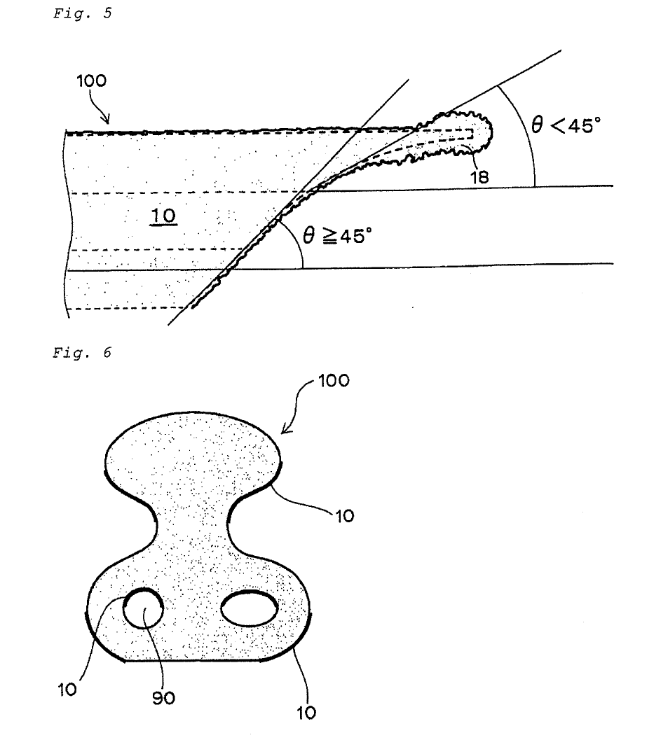

As shown in FIG. 5, in a case that the undercut portion 10 has two different steep angles θ for example, bulges 18 having sizes different from each other may arise at the undercut portion 10. Specifically, a predetermined region of the undercut portion 10 having the larger steep angle θ leads to a provision of the undercut portion 10 having the inclined configuration being close to the vertical configuration. In such a case, the smaller bulge may tend to arise. In contrast, a predetermined region of the undercut portion 10 having the smaller steep angle θ leads to a provision of the undercut portion 10 having the inclined configuration not being close to the vertical configuration. In such a case, the larger bulge may tend to arise. Although being merely described as an example, the bulge arising at the undercut portion having the steep angle of less than 45 degree may have a larger size than that arising at the undercut portion having the steep angle of 45 degree or more.

In light of the above matters, the pre-identification (i.e., identification in advance) of the predetermined region of the undercut portion 10′ where the steep angle θ is small and the region of the undercut portion 10′ where the steep angle θ is large is performed. A description over time will be made as follows. The entire surface of the three-dimensional shaped model 100 is divided into a plurality of pieces 11′ (see FIGS. 2A and 2B). Subsequently, the direction of the normal vector 12′ of each piece 11′ is calculated (see FIG. 2B) and the extraction of the piece 11′ having the normal vector 12′ with its direction downwardly oriented to the horizontal direction is performed (see FIG. 2C). After the extraction of the piece 11′ having the downward normal vector 12′, based on a difference of angle between the direction of the normal vector 12′ and the horizontal direction, it is determined whether the predetermined region of the undercut portion is a region having a small steep angle θ or the predetermined region of the undercut portion is a region having a small steep angle θ.

For example, in a case of the undercut portion having the larger steep angle θ, that is, in a case of undercut portion having the inclined configuration which is close to the vertical configuration, the size of the bulge may be relatively small, and a determination that the contour-upper surface of the solidified layer in the undercut portion having the larger steep angle is not subjected to the machine may be performed. As a result, a more limitation of a region to be subjected to the machine process is possible during the manufacture of the three-dimensional shaped object. Thus, it is possible to reduce the time of the machine process for the contour-upper surface of the solidified layer at the undercut portion. Therefore, the manufacture time of the three-dimensional shaped object can be finally more shortened, and thus the three-dimensional shaped object comprising the undercut portion can be manufactured more efficiently.

### <Machine Process Depending on Stacked Number of Solidified Layers>

In the present invention, a necessity of the machine process depending on the stacked number of the solidified layers for example may be determined in advance.

Specifically, in a case that the stacked number of the solidified layers exceeds the predetermined number, it is assumed that, due to the large number of stacked layers, the bulge arising at the undercut portion of each solidified layer may have a large size. In such a case, the bulge having the large size may obstruct the movement of the squeegee blade during the forming the powder layer. Thus, a formation of the path for the machine process by the computer processing may be determined. On the other hand, in a case that the stacked number of the solidified layers is less than the predetermined number, it is assumed that the bulge may not have a large size. As a result, no formation of the path for the machine process by the computer processing may be determined. The present invention is not limited to the above embodiment, and a necessity of the formation of the path for the machine process may be determined according to whether the value obtained by multiplying the stacked number of the solidified layer by a thickness of the solidified layer exceeds a predetermined value. Accordingly, the timing for the machine process can be reduced, and thus a more efficient manufacture of the three-dimensional shaped object comprising the undercut portion is possible.

Finally, effects resulting from the machine process for the contour-upper surface of the solidified layer in the undercut portion during the manufacture of the three-dimensional shaped object will be described.

In a case that the machine process for the contour-upper surface of the solidified layer in the undercut portion 10 during the manufacture of the three-dimensional shaped object, the bulge which may arise at the contour of the solidified layer in the undercut portion 10 can be removed from the contour-upper surface of the contour. As a result, it is possible to avoid the contact of the squeegee blade to be used for newly forming the next powder layer with the bulge, and thereby the peel off of a part of the solidified layer in the undercut portion 10 together with the bulge. Thus, the avoidance enables a new powder layer to be adequately formed on the solidified layer. As a result, a new solidified layer can be adequately formed in the formation region of the undercut portion 10 on the condition of the use of the light beam. Accordingly, an adequate manufacture of the three-dimensional shaped object 100 comprising the undercut portion 10 is possible.

As an example, as shown in FIG. 6, it is possible to adequately form a part (i.e., upper side) of a surface for forming an internal space 90 where the undercut part 10 may be formed and/or an outer surface of the three-dimensional shaped object 100 where the undercut part 10 may be formed. The adequate formation of the part of the surface for forming the internal space 90 where the undercut part 10 may be formed can lead to an adequate use of the internal space 90 as a temperature control pipe. As a result, it is possible to flow a temperature control media at a desired flow rate into the internal space 90, and thus the three-dimensional shaped object to be used as a mold can serve to provide an adequate temperature control function. Furthermore, the adequate formation of the outer surface of the three-dimensional shaped object 100 where the undercut portion 10 may be formed, can contribute to an avoidance of an occurrence of cracks on the outer surface. As a result, it is possible to adequately withstand or bear an external influence from the external (for example, external pressure). In a case that only the contour-upper surface of the solidified layer in the undercut portion 10 is subjected to the machine process, the bulge may remain on the outer surface (e.g., side surface) of the three-dimensional shaped object 100 where the undercut portion 10 may be formed. In this regard, the outer surface (e.g., side surface) of the three-dimensional shape object 100 where the undercut portion 10 may be formed may be adequately subjected to post-processing such as the machine process.

Although some embodiments of the present invention have been hereinbefore described, these are merely typical examples in the scope of the present invention. Accordingly, the present invention is not limited to the above embodiments. It will be readily appreciated by the skilled person that various modifications are possible without departing from the scope of the present invention.

It should be noted that the present invention as described above includes the following aspects.

The first aspect: A method for manufacturing a three-dimensional shaped object comprising an undercut portion by alternate repetition of a powder-layer forming and a solidified-layer forming, the repetition comprising: (i) forming a solidified layer by irradiating a predetermined portion of a powder layer with a light beam, thereby allowing a sintering of the powder in the predetermined portion or a melting and subsequent solidification of the powder; and
(ii) forming another solidified layer by newly forming a powder layer on the formed solidified layer, followed by an irradiation of a predetermined portion of the newly formed powder layer with the light beam, wherein a modeling process for pre-identifying the undercut portion is performed prior to a performance of the method.

The second aspect: The method according to the first aspect, wherein a surface of a model of the three-dimensional shaped object to be manufactured is divided into a plurality of pieces in the modeling process, and an extraction for a surface of the undercut portion is performed from the surface of the model of the three-dimensional shaped object, based on a direction of a normal vector of each of the plurality of the pieces. The third aspect: The method according to the second aspect, wherein the piece having the normal vector with its direction downwardly oriented to a horizontal direction is regarded as the surface of the undercut portion for the extraction. The fourth aspect: The method according to any one of the first to third aspects, wherein an extraction for a plurality of slice faces is performed from the model of the three-dimensional shaped object to be manufactured, a contour of a portion corresponding to the undercut portion in a contour of each of the extracted slice faces is identified, a selection of a plurality of points is performed from the identified contour, and a coordinate information on each of selected points is obtained.

The fifth aspect: The method according to any one of the first to fourth aspects, wherein the method comprises a performance of a machine process for a contour-upper surface of the solidified layer at the undercut portion.

The sixth aspect: The method according to the fifth aspect appended to the fourth aspect, wherein a formation of a path for the machine process is performed based on the coordinate information, and the contour-upper surface of the solidified layer at the undercut portion is subjected to the machine process in accordance with the path for the machine process. The seventh aspect: The method according to the fifth aspect or the sixth aspect, wherein, depending on a steep angle at the undercut portion, a necessity of the machine process for the contour-upper surface of the solidified layer at the undercut portion is determined.

### INDUSTRIAL APPLICABILITY

The manufacturing method of the three-dimensional shaped object according to an embodiment of the present invention can provide various kinds of articles. For example, in a case where the powder layer is a metal powder layer (i.e., an inorganic powder layer) and thus the solidified layer corresponds to a sintered layer, the three-dimensional shaped object obtained by an embodiment of the present invention can be used as a mold for a plastic injection molding, a press molding, a die casting, a casting or a forging. While on the other hand in a case where the powder layer is a resin powder layer (i.e., an organic powder layer) and thus the solidified layer corresponds to a cured layer, the three-dimensional shaped object obtained by an embodiment of the present invention can be used as a resin molded product.

### CROSS REFERENCE TO RELATED PATENT APPLICATION

The present application claims the right of priority of Japanese Patent Application No. 2016-016090 (filed on Jan. 29, 2016, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

100 Three-dimensional shaped object
100′ Three-dimensional shaped object model (i.e., model of three-dimensional shaped object)
10′ Undercut portion of three-dimensional shaped object model
10 Undercut portion of three-dimensional shaped object
11′ Piece
12′ Normal vector
13 Steep angle
19 Powder
22 Powder layer
24 Solidified layer
24a Contour-upper surface of solidified layer
L Light beam

1. A method for manufacturing a three-dimensional shaped object comprising an undercut portion by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by newly forming a powder layer on the formed solidified layer, followed by an irradiation of a predetermined portion of the newly formed powder layer with the light beam,
wherein a modeling process for pre-identifying the undercut portion is performed prior to a performance of the method.

2. The method according to claim 1, wherein a surface of a model of the three-dimensional shaped object to be manufactured is divided into a plurality of pieces in the modeling process, and an extraction for a surface of the undercut portion is performed from the surface of the model of the three-dimensional shaped object, based on a direction of a normal vector of each of the plurality of the pieces.

3. The method according to claim 2, wherein the piece having the normal vector with its direction downwardly oriented to a horizontal direction is regarded as the surface of the undercut portion for the extraction.

4. The method according to claim 1, wherein an extraction for a plurality of slice faces is performed from the model of the three-dimensional shaped object to be manufactured, a contour of a portion corresponding to the undercut portion in a contour of each of the extracted slice faces is identified, a selection of a plurality of points is performed from the identified contour, and a coordinate information on each of selected points is obtained.

5. The method according to claim 4, wherein the method comprises a performance of a machine process for a contour-upper surface of the solidified layer at the undercut portion.

6. The method according to claim 5, wherein a formation of a path for the machine process is performed based on the coordinate information, and the contour-upper surface of the solidified layer at the undercut portion is subjected to the machine process in accordance with the path for the machine process.

7. The method according to claim 5, wherein, depending on a steep angle at the undercut portion, a necessity of the machine process for the contour-upper surface of the solidified layer at the undercut portion is determined.
